(19) United States
(12) Patent Application Publication
(10) Pub. No.: US 2015/0249406 A1
(43) Pub. Date: Sep. 3, 2015

(54) Driving Device for Electric Motor

(71) Applicant: HITACHI AUTOMOTIVE SYSTEMS, LTD., Ibaraki (JP)

(72) Inventors: Tomonobu Koseki, Isesaki-shi (JP); Toshiaki Oyama, Isesaki-shi (JP)

(21) Appl. No.: 14/427,086

(22) PCT Filed: Jul. 10, 2014
(86) PCT No.: PCT/JP2014/068483

§ 371 Date: Mar. 10, 2015

(30) Foreign Application Priority Data
Aug. 2, 2013 (JP) 2013-161548

(51) Int. Cl. H02P 6/14; H02P 6/24

(52) U.S. Cl. CPC H02P 6/14; H02P 6/24

(57) ABSTRACT

The present invention relates to a driving device for an electric motor, including an inverter circuit and a power-supply relay disposed in a power-supply line of the inverter circuit, the power-supply relay including a semiconductor switch, and relates to a driving method therefor. The driving device of the present invention includes a first driver and a second driver that drive the power-supply relay, and when at least one of the first driver and the second driver outputs an ON signal, the power-supply relay is turned ON. This can reduce the disruption of power-supplying to the inverter circuit due to a failure in a driver.

### TECHNICAL FIELD

The present invention relates to a driving device for an electric motor, including an inverter circuit and a power-supply relay disposed in a power-supply line of the inverter circuit, and to a driving method therefor.

### BACKGROUND ART

Patent Document 1 discloses a driving device for an electric motor configured to supply battery voltage to an inverter circuit via a power-supply relay including a semiconductor switch.

### REFERENCE DOCUMENT LIST

### Patent Document

Patent Document 1: Japanese Patent Application Laid-open Publication No. 2011-244611

### SUMMARY OF THE INVENTION

### Problems to be Solved by the Invention

Such a driving device for an electric motor is configured to supply power to an inverter circuit via a power-supply relay, whereby if abnormality occurs, such as short circuit, the power-supply relay can be turned OFF to stop the supplying of power to the inverter circuit, and so the system can be guided to a safety side.

On the other hand, if a failure occurs in a driver of a semiconductor switch making up such a power-supply relay, power-supplying to the inverter circuit will stop even when there is no abnormality in other parts, thus leading to a failure in driving of the electric motor.

In view of such circumstance, the present invention aims to a driving device for an electric motor capable of reducing the disruption of power-supplying to an inverter circuit of the driving device due to a failure in a driver for driving a power-supply relay, and such a driving method.

### Means for Solving the Problems

To this end, a driving device for an electric motor according to the present invention includes: an inverter circuit that supplies electric power to the electric motor; a power-supply relay including a semiconductor switch disposed in a power-supply line for supplying electric power to the inverter circuit; and a first driver and a second driver that drive the power-supply relay. When at least one of the first driver and the second driver outputs an ON signal, the power-supply relay is turned ON.

A method for driving an electric motor according to the present invention is to drive an electric motor, in which a power-supply relay is disposed in a power-supply line for supplying electric power to an inverter circuit, the power-supply relay including a semiconductor switch, wherein when at least one of a plurality of drivers that drives the power-supply relay outputs an ON signal, the power-supply relay is turned ON.

### Effects of the Invention

According to the present invention as stated above, even when one of the first driver and the second driver fails, the other can output an ON signal, to turn the power-supply relay ON, whereby the power-supplying to the inverter circuit can be continued.

### BRIEF DESCRIPTION OF THE DRAWINGS

FIG. 1 illustrates the configuration of an electric power steering apparatus in an embodiment of the present invention.

FIG. 2 is a circuit diagram illustrating a driving device for an electric motor in the embodiment of the present invention.

FIG. 3 is a circuit diagram illustrating an exemplary driver in the embodiment of the present invention.

### MODE FOR CARRYING OUT THE INVENTION

The following describes an embodiment of the present invention.

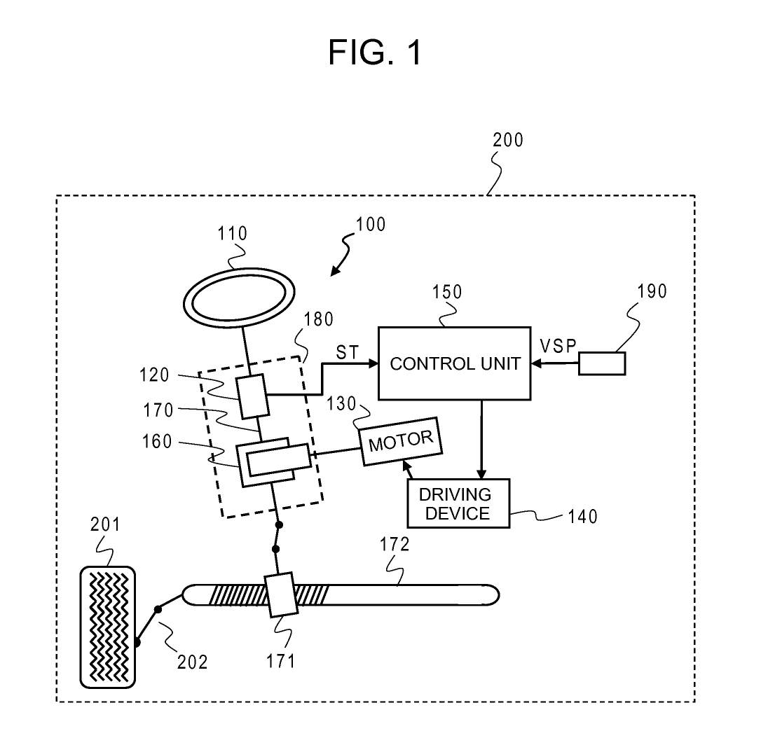

FIG. 1 illustrates an electric power steering apparatus as one application example of a driving device for an electric motor and a driving method.

An electric power steering apparatus 100 illustrated in FIG. 1 is installed in a vehicle 200 and is configured to make an electric motor 130 generate a steering assistance force, and includes a steering wheel 110, a steering torque sensor 120, electric motor 130, a driving device 140 for electric motor 130, a control unit 150 that makes up a control device for electric motor 130, a speed reducer 160 to reduce the rotational speed of electric motor 130 and transmit the reduced rate to a steering shaft 170, and the like.

Steering torque sensor 120 and speed reducer 160 are provided in a steering column 180 accommodating steering shaft 170 therein.

The leading end of steering shaft 170 is provided with a pinion gear 171, and the rotation of this pinion gear 171 moves a rack gear 172 horizontally to left and right with reference to the traveling direction of vehicle 200.

At each of both ends of rack gear 172, a steering mechanism 202 for a wheel 201 is provided, and so the horizontal movement of rack gear 172 can change the orientation of wheel 201.

Steering torque sensor 120 measures steering torque that is generated at steering shaft 170 when the operator of the vehicle performs steering operation, and outputs a signal ST of the measured steering torque to control unit 150.

Control unit 150 including a microcomputer receives, as an input, a signal VSP of vehicle speed that a vehicle-speed sensor 190 outputs as well as the steering torque signal ST.

Then control unit 150 controls driving device 140 in accordance with the steering torque signal ST, the vehicle-speed signal VSP, and the like, thus controlling torque generated at electric motor 130, i.e., a steering assistance force.

Control unit 150 and driving device 140 may be integrated in a configuration.

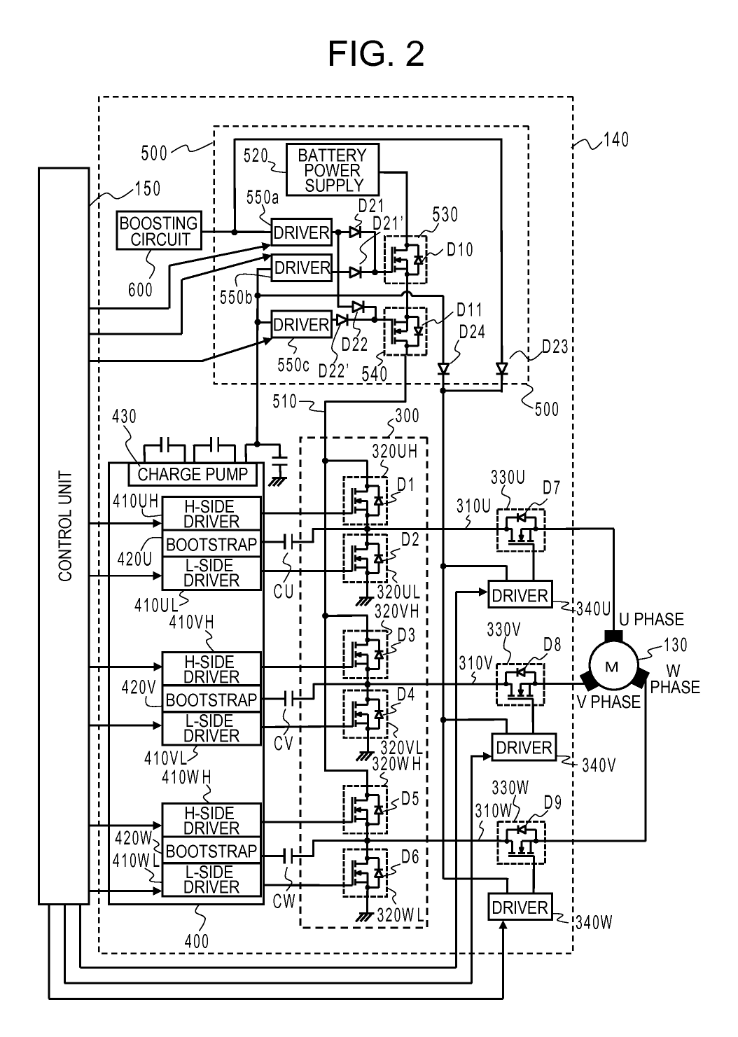

Referring next to FIG. 2, the following describes driving device 140 for electric motor 130 in details.

Electric motor 130 is a three-phase DC brushless motor having three-phase coils of U-phase, V-phase and W-phase, i.e., a three-phase synchronous electric motor.

Then driving device 140 includes an inverter circuit 300, a pre-driver 400 that drives inverter circuit 300, a power-supply relay device 500, and the like.

Inverter circuit 300 includes a three-phase bridge circuit provided with three sets of semiconductor switches 320UH, 320UL, 320VH, 320VL, 320WH, and 320WL that are configured to drive the U phase, the V phase and the W phase of electric motor 130 via driving lines 310U, 310V, and 310W.

The present embodiment includes, as semiconductor switches 320UH, 320UL, 320VH, 320VL, 320WH, and 320WL, N-channel metal-oxide-semiconductor field-effect transistors (MOSFETs).

Semiconductor switches 320UH and 320UL have a drain and a source that are connected in series between a power-supply line 510 and the ground. To the connecting point of semiconductor switch 320UH and semiconductor switch 320UL, one end of driving line 310U is connected, and the other end of driving line 310U is connected to the U phase of electric motor 130.

Semiconductor switches 320VH and 320VL have a drain and a source that are connected in series between power-supply line 510 and the ground. To the connecting point of semiconductor switch 320VH and semiconductor switch 320VL, one end of driving line 310V is connected, and the other end of driving line 310V is connected to the V phase of electric motor 130.

Semiconductor switches 320WH and 320WL have a drain and a source that are connected in series between power-supply line 510 and the ground. To the connecting point of semiconductor switch 320WH and semiconductor switch 320WL, one end of driving line 310W is connected, and the other end of driving line 310W is connected to the W phase of electric motor 130.

Driving lines 310U, 310V and 310W between inverter circuit 300 and the U phase, the V-phase and the W-phase of electric motor 130 are provided with relays 330U, 330V and 330W, respectively. The present example includes, as these relays 330U, 330V and 330W, N-channel MOSFETs.

Relays 330U, 330V, and 330W are driven by drivers 340U, 340V, and 340W, respectively.

Control unit 150 controls drivers 340U, 340V, and 340W to output a control signal to gates of the MOSFETs making up relays 330U, 330V, and 330W, thus individually controlling ON and OFF of relays 330U, 330V, and 330W.

When relays 330U, 330V, and 330W are in the OFF state, power-supplying from inverter circuit 300 to the U-phase, the V-phase and the W-phase is disrupted, and when relays 330U, 330V, and 330W are in the ON state, power can be supplied from inverter circuit 300 to the U-phase, the V-phase and the W-phase.

Pre-driver 400 includes: drivers 410VH, 410UH, and 410WH that drive upper arm switches 320VH, 320UH, and 320WH, respectively, in inverter circuit 300; and drivers 410VL, 410UL, and 410WL that drive lower arm switches 320VL, 320UL, and 320WL, respectively, in inverter circuit 300.

Pre-driver 400 can be made up of a silicon on insulator (SOI), whereby the floating capacitance can be reduced, and so pre-driver 400 can operate at higher speed and with lower power consumption. If a failure occurs at a specific part, the risk of such a failure spreading to another part and causing a failure there can be reduced.

Pre-driver 400 further includes bootstrap circuits 420V, 420U, and 420W that are boosting circuits to drive upper arm switches 320VH, 320UH, and 320WH with electric charge at bootstrap capacitors CU, CV and CW.

The output ends of drivers 410VH, 410UH, and 410WH are connected to the gates of MOSFETs 320VH, 320UH, and 320WH, respectively, and so MOSFETs 320VH, 320UH, and 320WH are ON and OFF controlled in accordance with the outputs of drivers 410VH, 410UH, and 410WH.

Similarly, the output ends of drivers 410VL, 410UL, and 410WL are connected to the gates of MOSFETs 320VL, 320UL, and 320WL, respectively, and so MOSFETs 320VL, 320UL, and 320WL are ON and OFF controlled in accordance with the outputs of drivers 410VL, 410UL, and 410WL.

Pre-driver 400 further includes a charge pump 430 that supplies electric power to drivers 410UH, 410UL, 410VH, 410VL, 410WH, and 410WL, drivers 340U, 340V, and 340W of relays 330U, 330V, and 330W, and drivers making up power-supply relay device 500. Charge pump 430 is a boosting circuit that boosts the power supply of pre-driver 400.

Drivers 410VH, 410UH, and 410WH are configured to drive MOSFETs 320VH, 320UH, and 320WH with voltage that is higher between the voltage at bootstrap circuits 420V, 420U, and 420W and the voltage at charge pump 430, and drivers 410VL, 410UL, and 410WL are configured to drive MOSFETs 320VL, 320UL, and 320WL with voltage that is higher between the voltage at a battery power supply 520 and the voltage at charge pump 430.

Power-supply relay device 500 includes battery power supply 520 as a power supply, a first power supply relay 530 and a second power supply relay 540 that include N-channel MOSFETs whose drain and source are connected in series with power-supply line 510 connecting battery 520 and inverter circuit 300, and a first driver 550a, a second driver 550b and a third driver 550c that drive first power supply relay 530 and second power supply relay 540.

Herein, in MOSFETs making up inverter circuit 300, relays 330U, 330V and 330W, first power supply relay 530, and second power supply relay 540, diodes D1 to D11 between their drains and sources are parasitic diodes, i.e., internal diodes.

The source of first power supply relay 530 and the source of second power supply relay 540 are connected so that parasitic diode D10 of first power supply relay 530 and parasitic diode D11 of second power supply relay 540 are in opposite directions in their forward directions letting current flow therein.

The gate of the MOSFET making up first power supply relay 530 is connected with the output ends of first driver 550a and second driver 550b, and the gate of the MOSFET making up second power supply relay 540 is connected with the output ends of first driver 550a and third driver 550c.

When at least one of the outputs of first driver 550a and second driver 550b is at a high level, first power supply relay 530 is in ON state in which current flows between the drain and the source, and when at least one of the outputs of first driver 550a and third driver 550c is at a high level, second power supply relay 540 is in ON state in which current flows between the drain and the source.

In a line connecting the output end of first driver 550a and the gate of the MOSFET making up first power supply relay 530, a first diode D21 is placed so as to let current flow in the direction from first driver 550a to first power supply relay 530.

In a line connecting the output end of first driver 550a and the gate of the MOSFET making up second power supply relay 540, a second diode D22 is placed so as to let current flow in the direction from first driver 550a to second power supply relay 540.

In a line connecting the output end of second driver 550b and the gate of the MOSFET making up first power supply relay 530, a third diode D21′ is placed so as to let current flow in the direction from second driver 550b to first power supply relay 530.

In a line connecting the output end of third driver 550c and the gate of the MOSFET making up second power supply relay 540, a fourth diode D22′ is placed so as to let current flow in the direction from third driver 550c to second power supply relay 540.

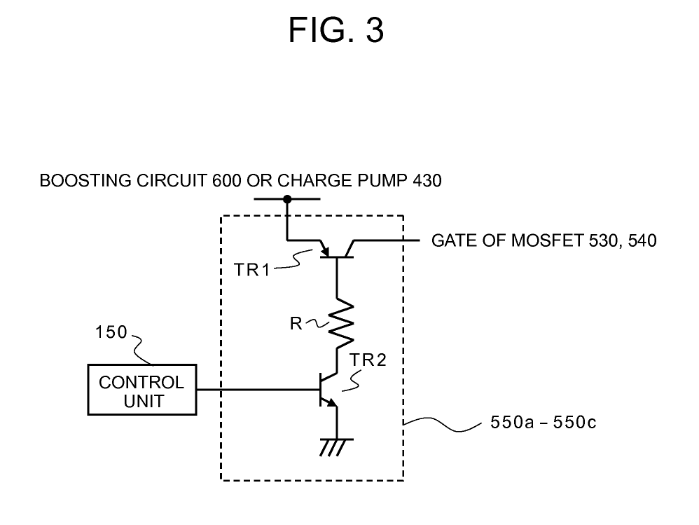

When circuits made up of bipolar transistors as illustrated in FIG. 3 are used for drivers 550a to 550c, for example, diodes D21, D22, D21′, and D22′ may be omitted in lines connecting drivers 550a to 550c and the gates of MOSFETs 530 and 540 making up power supply relays 530 and 540.

Driver 550a to 550c in FIG. 3 includes a PNP transistor TR1, a resistor R, and a NPN transistor TR2. PNP transistor TR1 has an emitter and a collector that are connected in series between a boosting circuit 600 as a power supply or charge pump 430 and the gate of MOSFET 530, 540 making up power supply relay 530, 540.

Resistor R is connected in series between the base of PNP transistor TR1 and the ground. NPN transistor TR2 has a collector and an emitter that are connected in series between resistor R and the ground.

When a control signal from control unit 150 is output to the base of NPN transistor TR2 and a high-level signal is output to the base of NPN transistor TR2, power is supplied to the gate of MOSFET 530, 540 making up power supply relay 530, 540 via PNP transistor TR1.

Herein, pre-driver 400 made up of a SOI and another device may be integrated.

For instance, pre-driver 400 and boosting circuit 600 may be integrated, or pre-driver 400, driver 550a, and diodes D21 and D22 may be integrated.

Alternatively, pre-driver 400, driver 550a, and diodes D21, D22 and D21′ may be integrated, or pre-driver 400, drivers 550a to 550c, diodes D21, D22, D21′ and D22′, and drivers 340U, 340V and 340W of the relays may be integrated.

Power is supplied to first driver 550a from boosting circuit 600, and power is supplied to second driver 550b and third driver 550c from charge pump 430 provided at pre-driver 400.

Electric power is supplied to drivers 340U, 340V, and 340W of relays 330U, 330V, and 330W from boosting circuit 600 and charge pump 430.

In a line connecting boosting circuit 600 and each driver 340U, 340V and 340W, a third diode D23 is placed, and in a line connecting charge pump 430 and each driver 340U, 340V, and 340W, a fourth diode D24 is placed. Third diode D23 and fourth diode D24 are connected in parallel and both let current flow in the direction toward drivers 340U, 340V, and 340W.

Drivers 340U, 340V, 340W, 550a, 550b, 550c, 410VH, 410UH, 410WH, 410VL, 410UL, and 410WL making up driving device 140 as stated above are controlled individually by control unit 150 including a microcomputer.

That is, control unit 150 controls drivers 550a, 550b and 550c, thus supplying a control signal to the gates of the MOSFETs making up first power supply relay 530 and second power supply relay 540 of power-supply relay device 500 and controlling ON and OFF of first power supply relay 530 and second power supply relay 540.

Then control unit 150 outputs a pulse width modulation (PWM) signal to each driver 410VH, 410UH, 410WH, 410VL, 410UL, or 410WL of pre-driver 400.

Then drivers 410VH, 410UH, 410WH, 410VL, 410UL, and 410WL supply a driving signal based on the PWM signal to the gates of semiconductor switches 320UH, 320UL, 320VH, 320VL, 320WH, and 320WL of inverter circuit 300 in accordance with the PWM signal, to control ON and OFF of semiconductor switches 320UH, 320UL, 320VH, 320VL, 320WH, and 320WL, thus individually controlling the energization of the respective phases of electric motor 130.

Control unit 150 further controls drivers 340U, 340V, and 340W individually to supply a control signal from these drivers 340U, 340V, and 340W to the gates of the MOSFETs making up relays 330U, 330V, and 330W, thus controlling ON and OFF of relays 330U, 330V, and 330W individually.

For the driving of electric motor 130, control unit 150 outputs an ON signal to drivers 550a, 550b, and 550c of power-supply relay device 500 to control first power supply relay 530 and second power supply relay 540 to be ON, and then, outputs an ON signal to drivers 340U, 340V, and 340W to control relays 330U, 330V, and 330W to be ON.

Control unit 150 controls the ON and OFF of semiconductor switches 320UH, 320UL, 320VH, 320VL, 320WH, and 320WL of inverter circuit 300 by PWM, thus driving electric motor 130.

Herein, control unit 150 changes the duty ratio of a PWM signal in accordance with a steering torque signal ST, a vehicle-speed signal VSP, and the like, to control the rotational speed of electric motor 130.

If power-supplying to electric motor 130 stops due to a failure in circuit, for example, relays 330U, 330V, and 330W are controlled to be OFF so as to prevent electric motor 130 from serving as a generator to be resistant to wheel operation.

Hereinafter, the operation of electric motor 130 serving as a generator to be resistant to wheel operation will be called electric brake.

When power-supplying to electric motor 130 is to be stopped due to a failure in circuit for fail-safe, control unit 150 controls first power supply relay 530 and second power supply relay 540 in power-supply relay device 500 to be OFF to disrupt the supplying of power to inverter circuit 300, and controls all of the semiconductor switches in inverter circuit 300 to be OFF, thus protecting the circuit and reducing unexpected generation of a steering assistance force.

Control unit 150 further controls the MOSFETs making up relays 330U, 330V, and 330W to be OFF via drivers 340U, 340V, and 340W, thus disrupting a driving current from inverter circuit 300 to electric motor 130. This can reduce the generation of electric brake by disconnecting a current path to generate a closed loop when a circuit failure occurs.

The following describes the action of power-supply relay device 500.

Since power-supply relay device 500 includes first power supply relay 530 and second power supply relay 540 that are semiconductor relays including semiconductor devices such as MOSFETs, the device can be made compact and can improve reliability as compared with the case including an electromagnetic relay, ON and OFF of which are switched by moving a contact thereof physically using an electromagnet.

Although MOSFETs making up first power supply relay 530 and second power supply relay 540 include parasitic diodes D10 and D11, they are connected so that their forward directions letting current flow in parasitic diodes D10 and D11 are reversed therebetween.

This means that, when first power supply relay 530 and second power supply relay 540 are controlled to be OFF state, power-supplying to inverter circuit 300 via parasitic diodes D10 and D11 of first power supply relay 530 and second power supply relay 540 can be reduced.

First power supply relay 530 is in ON state when at least one of the outputs of first driver 550a and second driver 550b is ON, and second power supply relay 540 is in ON state when at least one of the outputs of first driver 550a and third driver 550c is ON.

That is, first power supply relay 530 and second power supply relay 540 are configured to be in ON state when at least one of the outputs of their corresponding two drivers is ON.

That is, even when one of drivers 550a, 550b and 550c fails so that the output thereof is fixed to OFF state, first power supply relay 530 and second power supply relay 540 can be turned ON in response to an ON instruction from the power-supply relay of control unit 150, to supply electric power to inverter circuit 300.

For instance, when driver 550a fails so that the output thereof is fixed to OFF state, then first power supply relay 530 is turned ON in response to turning ON of the output of driver 550b, and second power supply relay 540 is turned ON in response to turning ON of the output of driver 550c.

When driver 550b fails so that the output thereof is fixed to OFF state, then first power supply relay 530 is turned ON in response to turning ON of the output of driver 550a, and second power supply relay 540 is turned ON in response to turning ON of at least one of driver 550a and driver 550c.

When driver 550c fails so that the output thereof is fixed to OFF state, then first power supply relay 530 is turned ON in response to turning ON of at least one of driver 550a and driver 550b, and second power supply relay 540 is turned ON in response to turning ON of driver 550a.

In this way, even when one of drivers 550a, 550b and 550c fails so that the output thereof is fixed to OFF state, control unit 150 controls drivers 550a, 550b, and 550c to be ON, thus controlling both of first power supply relay 530 and second power supply relay 540 to be ON and supplying the power to inverter circuit 300 successfully.

If boosting circuit 600 fails so that power cannot be supplied to first driver 550a and so the output of first driver 550a cannot be turned ON, then power will be supplied to second driver 550b and third driver 550c from charge pump 430 that is independent of boosting circuit 600, and so the outputs of second driver 550b and third driver 550c are turned ON to let first power supply relay 530 and second power supply relay 540 in ON state.

On the other hand, if charge pump 430 fails so that power cannot be supplied to second driver 550b and third driver 550c and so the outputs of second driver 550b and third driver 550c cannot be turned ON, then power will be supplied to first driver 550a from boosting circuit 600 that is independent of charge pump 430, and so the output of first driver 550a is turned ON to let first power supply relay 530 and second power supply relay 540 in ON state.

In this way, even when one of boosting circuit 600 and charge pump 430 fails, first power supply relay 530 and second power supply relay 540 can be controlled to be ON and electric power can be supplied to inverter circuit 300.

The flow of electric power from charge pump 430 to the side of first driver 550a is reduced by diodes D21 and D22.

In this way, first power supply relay 530 and second power supply relay 540 are configured to be turned ON when one of their corresponding two drivers is turned ON.

Furthermore, since boosting circuit 600 configured to supply power to one of the two drivers and charge pump 430 configured to supply power to the other are provided separately, first power supply relay 530 and second power supply relay 540 can be turned ON when power is supplied to the drivers from one of boosting circuit 600 and charge pump 430.

That is, even when one of drivers 550a, 550b and 550c fails or one of boosting circuit 600 and charge pump 430 fails, first power supply relay 530 and second power supply relay 540 can be turned ON to supply electric power to inverter circuit 300, whereby electric motor 130 can be driven so as to generate a steering assistance force.

This means that when drivers 550a, 550b and 550c, boosting circuit 600 and charge pump 430 fail in the state enabling normal driving control of electric motor 130, power can be supplied to inverter circuit 300 to drive electric motor 130, and so a steering assistance force can be generated continuously, meaning that an increase in steering force for the operator of the vehicle can be reduced.

Since pre-driver 400 as stated above is provided with charge pump 430 as well as bootstrap circuits 420V, 420U, and 420W for the phases, even when the boosting function of charge pump 430 fails, semiconductor switches 320VH, 320UH, and 320WH as the upper arm switches can be driven with the voltage of bootstrap capacitors of bootstrap circuits 420V, 420U, and 420W.

In bootstrap circuits 420V, 420U, and 420W, when the duty ratio for PWM control of electric motor 130 is set at 100% or 0%, their bootstrap capacitors cannot be charged, leading to a failure to drive semiconductor switches 320VH, 320UH, and 320WH with the voltage of bootstrap capacitors.

When charge pump 430 works normally, however, even when the duty ratio is set at 100% or 0%, the power-supply voltage required for the driving of semiconductor switches 320VH, 320UH, and 320WH can be supplied from charge pump 430.

Furthermore, the power can be supplied from boosting circuit 600 and charge pump 430 to each of drivers 340U, 340V, and 340W of relays 330U, 330V, and 330W, and so if one of boosting circuit 600 and charge pump 430 fails, the power can be supplied from the other to turn relays 330U, 330V, and 330W ON.

In this way, when electric motor 130 is driven, even when at least one of boosting circuit 600 and charge pump 430 fails, the U phase, the V phase and the W phase of electric motor 130 can be driven to generate a steering assistance force.

In other words, boosting circuit 600 and charge pump 430 function as a backup power supply mutually, and so can reduce a failure to drive electric motor 130 due to a failure in the power-supply circuit.

As stated above, driving device 140 of electric motor 130 enables continuous driving of electric motor 130 even when a failure occurs in the boosting circuit or the drivers. This can reduce an increase in steering force for the operator of the vehicle, due to a failure to generate a steering assistance force immediately after the failure in the boosting circuit or the drivers.

Such technical concept described in the aforementioned embodiment can be combined for use appropriately as long as no conflict occurs.

The details of the present invention are specifically described referring to the preferable embodiment, and it is obvious for one skilled in the art to make various modifications based on the basic technical concept and teachings of the present invention.

For instance, two sets of the combinations of first power supply relay 530 and second power supply relay 540 may be connected in series, so that four MOSFETs in total can be connected in series in power-supply line 510.

In this case, if a failure occurs at a MOSFET having a parasitic diode D whose current direction is toward battery 520 is fixed to ON state, another MOSFET having a parasitic diode D whose current direction is toward battery 520 may be controlled to be OFF, whereby the power-supplying to inverter circuit 300 can be stopped.

The above embodiment exemplifies the combination of two power-supply relays 530 and 540, and three drivers 550a, 550b and 550c. In another configuration, one driver receiving power-supplying from boosting circuit 600 and the other driver receiving power-supplying from charge pump 430 may be provided so that the outputs of these two drivers are supplied to first power supply relay 530 and second power supply relay 540, respectively.

The combination of one driver receiving power-supplying from boosting circuit 600 and the other driver receiving power-supplying from charge pump 430 may be provided for each of first power supply relay 530 and second power supply relay 540, i.e., four drivers in total may be provided in still another configuration.

In a further configuration, the outputs from three or more drivers are output to one power-supply relay, and at least one of the three or more drivers may receive power-supply from boosting circuit 600 and at least one of the three or more drivers may receive power-supply from charge pump 430.

The semiconductor switches making up the relays and the inverter circuit are not limited to N-channel MOSFETs, and other semiconductor switches may be used. For instance, the semiconductor switches making up relays 330U, 330V, and 330W may be P-channel MOSFETs.

Furthermore, a N-channel MOSFET having a Schottky barrier diode (SBD) connected in series with a parasitic diode thereof and letting current flow in the direction opposite of the direction in which the parasitic diode flows current may be used as a semiconductor switch making up relays 330U, 330V, 330W and power-supply relay device 500.

Such a N-channel MOSFET having a SBD formed therein is disclosed in Japanese Patent Application Laid-open Publication No. H07-015009, for example.

Then when such a N-channel MOSFET having a SBD formed therein is used as first power supply relay 530 of power-supply relay device 500, second power supply relay 540 and driver 550c can be omitted.

Electric motor 130 is not limited to the one configured to generate a steering assistance force at electric power steering apparatus 100, which may be an electric motor configured to drive a fluid pump to circulate oil in hydraulic equipment for vehicle or coolant water in an internal-combustion engine, for example.

Electric motor 130 is not limited to a three-phase DC brushless motor, which may be a synchronous electric motor having four phases or more coils.

### REFERENCE SYMBOL LIST

100 Electric power steering apparatus

130 Electric motor

140 Driving device

150 Control unit

300 Inverter circuit

330U, 330V, 330W Relay

340U, 340V, 340W Driver

400 Pre-driver

420V, 420U, 420W Bootstrap circuit

430 Charge pump

500 Power-supply relay device

530 First power supply relay

540 Second power supply relay

550a, 550b, 550c Driver

600 Boosting circuit

1.-15. (canceled)

16. A driving device for an electric motor, comprising:
an inverter circuit that supplies electric power to the electric motor;
a first power-supply relay including a semiconductor switch disposed in a power-supply line for supplying electric power to the inverter circuit;
a first driver and a second driver that drive the first power-supply relay;
a second power-supply relay including a semiconductor switch connected to the first power-supply relay; and
a third driver that drives the second power-supply relay,
wherein when at least one of the first driver and the second driver outputs an ON signal, the first power-supply relay is turned ON,
wherein the second power-supply relay is connected with at least one of the first driver and the second driver as well as with the third driver, and when at least one of the drivers connected to the second power-supply relay outputs an ON signal, the second power-supply relay is turned ON.

17. The driving device for the electric motor, according to claim 16, wherein when the first driver and the second driver operate normally, the first driver and the second driver both output an ON signal to turn the first power-supply relay ON.

18. The driving device for the electric motor, according to claim 16, further comprising a first boosting circuit for boosting a power supply of the first driver and a second boosting circuit for boosting a power supply of the second driver, the first and second boosting circuits being provided separately.

19. The driving device for the electric motor, according to claim 18, wherein one of the first boosting circuit and the second boosting circuit is a boosting circuit that boosts a power supply of a pre-driver that drives the inverter circuit.

20. The driving device for the electric motor, according to claim 18, further comprising a phase relay in a line connecting the inverter circuit and a coil of the electric motor, the phase relay including a semiconductor switch, the phase relay being provided with a driver, to which power is supplied from the first boosting circuit and the second boosting circuit.

21. The driving device for the electric motor, according to claim 20, wherein a combination of the phase relay and the driver of the phase relay is provided for each phase of the electric motor.

22. The driving device for the electric motor, according to claim 16, wherein the semiconductor switch making up the second power-supply relay has a parasitic diode letting current flow in a first direction, and the semiconductor switch making up the first power-supply relay has a parasitic diode letting current flow in a second direction, the first direction being opposite to the second direction.

23. The driving device for the electric motor, according to claim 16, wherein at least one of the first driver and the second driver connected to the second power-supply relay, and the third driver are supplied with power via different boosting circuits.

24. The driving device for the electric motor, according to claim 23, wherein a boosting power supply to be supplied to the first driver or the second driver connected to the second power-supply relay is not shared as a power-supply of a pre-driver of the inverter circuit.

25. The driving device for the electric motor, according to claim 24, further comprising a bootstrap circuit as a boosting circuit for the pre-driver.

26. The driving device for the electric motor, according to claim 16, further comprising a diode disposed between the first, second and third drivers and the semiconductor switch making up the first power-supply relay, the diode letting current flow in a direction toward the first power-supply relay.

27. The driving device for the electric motor, according to claim 16, wherein a pre-driver that drives the inverter circuit is supplied with power from at least two boosting-circuit systems.

28. The driving device for the electric motor, according to claim 16, wherein a pre-driver that drives the inverter circuit includes a silicon on insulator (SOI).
